(19) United States
(12) Patent Application Publication
(10) Pub. No.: US 2008/0166175 A1
(43) Pub. Date: Jul. 10, 2008

(54) Holding and Using an Electronic Pen and Paper

(75) Inventors: Arkady Pittel, Brookline, MA (US); Stanislav V. Elektrov, Needham, MA (US); Andrew M. Goldman, Stow, MA (US); Lawrence Fine, Brookline, MA (US); Eugene Goldenberg, Pawtucket, RI (US); Ilya Pittel, Brookline, MA (US)

Correspondence Address: FISH & RICHARDSON PC, P.O. BOX 1022, MINNEAPOLIS, MN, 55440-1022, US

(73) Assignee: CandleDragon, Inc., Brookline, MA (US)

(21) Appl. No.: 11/620,201

(22) Filed: Jan. 5, 2007

(51) Int. Cl. B43K 29/00; B43K 23/02

(52) U.S. Cl. 401/195; 401/131

(57) ABSTRACT

A housing contains electronics used in determining locations of a writing instrument based on wireless signals, defines a chamber in which the writing instrument may be held when not in use, and includes a retention element to retain the writing instrument from falling out of the chamber.

In general, in one aspect, a writing instrument includes an elongate pen body, an electrical contact on a surface of the pen body, and a light source disposed near an end of the pen body. The light source includes a light guide having an optically conductive portion and an optically reflective portion.

This patent is related to U.S. Pat. No. 6,577,299, Electronic Portable Pen Apparatus and Method, issued Jun. 10, 2003, and U.S. patent application Ser. Nos. 10/623,284, Tracking Motion of a Writing Instrument, filed Jul. 17, 2003, Ser. No. 11/327,292, Light Sources for Digital Pen, 11/327,302, Capturing Handwriting, and 11/327,303, Electronic Pen Holding, all filed Jan. 6, 2006 as continuations of application Ser. No. 10/623,284, 09/832,340, Using Handwritten Information, filed Apr. 10, 2001, Ser. No. 09/991,539, Capturing Hand Motion, filed Nov. 21, 2001, and Ser. No. 11/418,987, Efficiently Focusing Light, filed May 4, 2006, all incorporated here by reference.

### BACKGROUND

This description relates to holding and using an electronic pen and paper.

Wireless electronic pens sometimes work with external sensors. Such sensors are sometimes mounted on a writing surface, for example, at the head of a clipboard or at the corners of a marker board.

### SUMMARY

In general, in one aspect, a housing contains electronics used in determining locations of a writing instrument based on wireless signals, defines a chamber in which the writing instrument may be held when not in use, and includes a retention element to retain the writing instrument from falling out of the chamber.

Implementations may include one or more of the following features. The retention element is configured to retain the writing instrument in a direction normal to its length. The retention element is configured to retain the writing instrument in a direction parallel to its length. The chamber is defined by lower and upper plates extending beyond a body of the housing. The upper plate includes two portions separated by a void. The extent of the upper plate beyond the body defines a void. A center spring extends from the lower plate toward the void. The extent of the lower plate beyond the body defines a void. A center spring extends from the upper plate toward the void. A rib extends from the lower plate toward the upper plate. A circuit provides power to a writing instrument. The circuit to provide power to the writing instrument includes a center spring and at least one other contact. A rib extends from the upper plate toward the lower plate. A center spring extends from the lower plate toward the void. The center spring and the rib are configured to releasably hold the writing instrument between them. The chamber is defined by a first end unit and a second end unit extending from first and second ends of a body of the housing. The first and second end units each contain a resilient structure, in which the resilient structures define a space between them within which the writing instrument may be held such that one of the resilient structures presses on one end of the writing instrument and the other resilient structure presses on the other end of the writing instrument. A switch is triggered when the writing instrument is present in the chamber. A switch is triggered when the writing instrument is removed from the chamber. Sensors are located near openings in the housing. Lenses are located in the openings, and the housing includes a first section and a second section, the first section defines the openings, and the second section can be removed from the first section without compromising the operation of the sensors. A button receives user input. The housing includes a status indicator. The housing has an attached writing surface.

A wireless communications interface is included. An electronic communications interface is included. The electronic communications interface is located on a face of the housing opposite the chamber. The communications interface is located on an end face of the housing. A foot is attached to a bottom surface of the housing and has a higher traction than a material of which the bottom surface is composed. A board is adapted to connect to the housing. The board includes protrusions to be inserted into holes in the housing. The board includes holes to accommodate protrusions on the housing, in which the board includes springs adapted to apply pressure to the housing to maintain pressure between a surface of the housing and the board. The springs are adapted to apply pressure to the housing through tabs extending from first and second ends of the housing. The housing, the board, and the springs are adapted to hold paper between the housing and the board. The board also includes an edge boundary to position the sheet of paper relative to the housing when the housing is connected to the board. The board is sized to accommodate a letter sized sheet of paper in either a landscape orientation or a portrait orientation relative to the housing. The board is sized to be inserted into a pad of paper. The board is configured to position the housing at the top of a pad of paper that is bound along one side. The board is configured to position the housing at the side of a pad of paper that is bound along its top edge. The board is adapted to connect to the housing in a position such that sheets of paper in a pad on the board can be flipped without blocking sensors included in the housing.

The housing encloses a circuit board having a first section, a second section, and a third section. The first section includes communication circuitry and the second and third sections include sensor circuitry. The first section also includes a processor. The first, second, and third sections are separated sections of a single printed circuit board. The second and third sections are not coplanar with the first section.

In general, in one aspect, a housing defines a chamber in which a writing instrument is held when not in use, is configured to be part of a clipboard structure for holding paper that is to be written on using the writing instrument, and is configured to communicate wirelessly with the writing instrument to determine locations of the writing instrument when the writing instrument is used to write on the paper.

In general, in one aspect, a writing instrument includes an elongate pen body, a first electrical contact on a surface of the pen body, a writing tip disposed at an end of the pen body, and a light source disposed near the writing tip.

Implementations may include one or more of the following features. The pen body includes electronics for generating light. The pen body includes a power supply. A second electrical contact is disposed near the writing tip. The first and second electrical contacts are adapted to receive power to charge the power supply. A second electrical contact and a third electrical contact are included, and electronics in the pen are adapted to provide power of a first polarity from the first contact to the power supply, and to provide power of a second polarity from the second and third contacts to the power supply. The first electrical contact extends over a circumference of the pen.

The light source includes a light guide to direct light from an illumination source within the pen body to a location outside the apparatus. The illumination source includes two or more LEDs and the light guide is configured to mix light form the LEDs into a uniform illumination field. The illumination field extends 360 degrees around the apparatus. The light guide includes a tapered section having a first end of a first diameter and a second end of a second diameter. The light guide includes a section having a uniform cross section of the first diameter and coupled to the tapered section at the first end of the tapered section. The light guide includes a reflective surface to cause light conducted through the light guide to exit through an outer surface of the light guide. The reflective surface includes a second electrical contact. The reflective surface defines a conical frustum having an angle of 45° from an axis of the light guide. A narrow end of the conical section is located about 1 mm from the end of the pen body. The light guide includes a channel to accommodate a pen cartridge through an axis of the light guide. The channel is configured to control the position of the pen cartridge. The writing tip includes a tip of a pen cartridge located within the pen body. The pen body also includes a guide member for receiving a pen cartridge. A coil spring, an end cap, and a flat spring are included, in which a portion of the writing tip, the guide member, the coil spring, the end cap, and the flat spring are each electrically conductive and together form a complete circuit path from the portion of the writing tip to a circuit contact. An end cap is disposed within the pen body and arranged to be connected to a pen cartridge. A grip is disposed between the first electrical contact and the light source. A switch is triggered when pressure is applied to the writing tip. The switch includes a first switch contact, a second switch contact, a switch spring, and a mechanical linkage from the writing tip to the switch spring, such that when pressure is applied to the writing tip, the mechanical linkage causes the switch spring to complete a circuit between the first and second switch contacts, and when pressure is not applied to the writing tip, the switch spring breaks the circuit. When pressure is not applied to the writing tip, there is a gap of around 0.2 mm between the switch spring and one or the first and second switch contacts.

In general, in one aspect, a sensing device is attached to a clipboard, paper is attached to the clipboard, the paper is written on using a writing instrument wirelessly coupled to the sensing device, and at the sensing device a record is generated of the writing of the writing instrument.

Implementations may include one or more of the following features. The record is generated by storing raw data representing movement of the writing instrument. The record is generated by applying calibration parameters to adjust raw data and storing adjusted data representing movement of the writing instrument.

In general, in one aspect, a sensing device is positioned in a known location relative to a pre-printed form, the form is written on using a writing instrument wirelessly coupled to the sensing device, a record of the writing of the writing instrument is generated, and the record is associated with fields on the form.

In general, in one aspect, a housing contains electronics used in determining locations of a writing instrument based on wireless signals and defines a chamber in which the writing instrument may be held when not in use.

In general, in one aspect, a housing contains electronics used in determining locations of a writing instrument based on wireless signals, and defines a chamber in which the writing instrument may be held when not in use. The electronics include electrical contacts, such that when the writing instrument is present in the chamber, the contacts will couple to contacts on the writing instrument and provide power to the writing instrument.

In general, in one aspect, a housing contains electronics used in determining locations of a writing instrument based on wireless signals, and defining a chamber in which the writing instrument may be held when not in use. The electronics includes three electrical contacts, such that when the writing instrument is present in the chamber, at least two of the contacts will couple to contacts on the writing instrument. The electronics detect which electrical contacts are coupled to the contacts on the writing instrument and provide a voltage to the identified contacts to charge a power supply in the writing instrument. In some implementations, the three electrical contacts include a contact located in the center of the chamber and contacts located at first and second ends of the chamber.

In general, in one aspect, a writing instrument includes an elongate pen body, a first electrical contact on a surface of the pen body, and a light source disposed near an end of the pen body. The light source includes a light guide having an optically conductive portion and an optically reflective portion. The optically reflective portion is also electrically conductive and constitutes a second electrical contact.

In general, in one aspect, a housing contains electronics used in determining locations of a writing instrument based on wireless signals, and defines a chamber in which the writing instrument may be held when not in use. A clipboard is sized to accommodate a sheet of paper, the housing and the clipboard having mating features to removably couple the housing to the clipboard. In some implementations, the mating features may include protrusions on the clipboard and holes in the housing. The mating features may include springs attached to the clipboard and tabs extending from the housing.

In general, in one aspect, a clipboard for use with a housing contains electronics used in determining locations of a writing instrument based on wireless signals, and includes coupling features for aligning the housing in a controlled position and alignment features for aligning paper in a known position relative to the controlled position of the housing.

In general, in one aspect, a clipboard is configured for use with a housing containing electronics used in determining locations of a writing instrument based on wireless signals, includes coupling features for aligning the housing in a controlled position, and is shaped to accommodate paper with a long edge of the paper aligned to the housing.

In general, in one aspect, a clipboard is configured for use with a housing containing electronics used in determining locations of a writing instrument based on wireless signals, includes coupling features for aligning the housing in a controlled position, and paper retaining features to retain paper in a fixed location relative to the controlled position of the housing between times when the housing is removed and the housing is attached.

In general, in one aspect, a light guide is adapted for use in a writing instrument, the light guide including a tapered section defining an axis and having a first end of a first diameter and a second end of a second diameter, the first end being adapted to receive light, and the second end being adapted to reflect the light received at the first end from a path from the first end to the second end and generally parallel to the axis to a path exiting the light guide in a direction generally perpendicular to the axis.

Implementations may include one or more of the following features. A face of the second end may define a conical frustum coaxial with recessed into the tapered section. The conical frustum may have an angle of around 45 degrees. The conical frustum begins at a distance of about 1 mm from a point where the light guide is to exit a body of the writing instrument.

In general, in one aspect, a light guide is adapted for use in a writing instrument, the light guide including a first section having a first diameter and defining an axis, a tapered section coaxial with the first section and having a first end of the first diameter coupled to the first section and a second end of a second diameter, the first section being adapted to receive light and direct it to the tapered, and the second end being adapted to reflect light received from the first section from a path generally parallel to the axis to a path generally perpendicular to the axis.

In general, in one aspect, a writing instrument includes an elongate pen body, a writing tip disposed at an end of the pen body, a light source disposed near the writing tip, a switch to detect when pressure is applied to the writing tip, and a contact for receiving power to charge electronics within the apparatus. In some implementations, the switch may be configured to be activated without allowing significant movement of the writing tip relative to the pen body. The switch may be configured to be activated while allowing axial movement of the writing tip of only 0.2 mm relative to the pen body.

In general, in one aspect, a writing instrument includes a pen body, a light guide partially disposed within the pen body, and outside diameter of the light guide being about equal to an inside diameter of the pen body, a light source disposed within the pen body, a fiber optic fiber configured to couple light from the light source to the light guide, and a reflector disposed at an end of the light guide outside the pen body. In some implementations, the light guide may define a channel along an axis of the pen body sized to accommodate a pen cartridge. The reflector may be configured to reflect light from a direction substantially parallel to an axis of the pen body to a direction substantially perpendicular to the axis of the pen body. The light guide may have a cylindrical shape of about constant diameter along its length.

Other features and advantages will be apparent from the description and the claims.

### DESCRIPTION

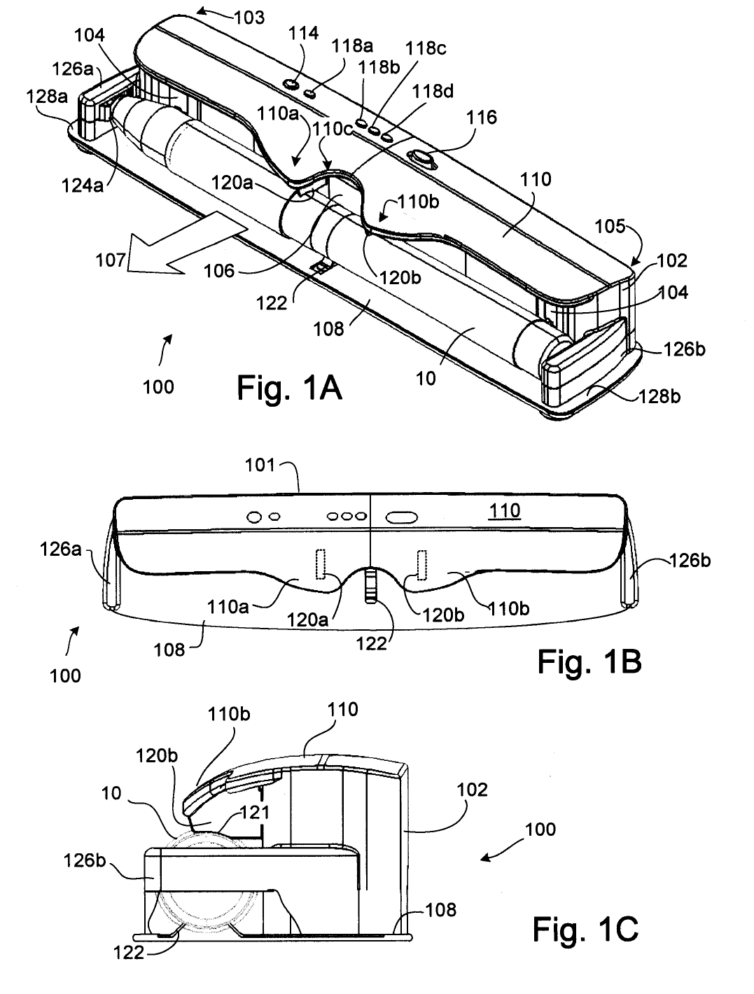

FIGS. 1A, 13, and 21 are front isometric views of a penholder and pen.

FIG. 1B is a top view of a penholder.

FIG. 1C is a side view of part of a penholder and pen.

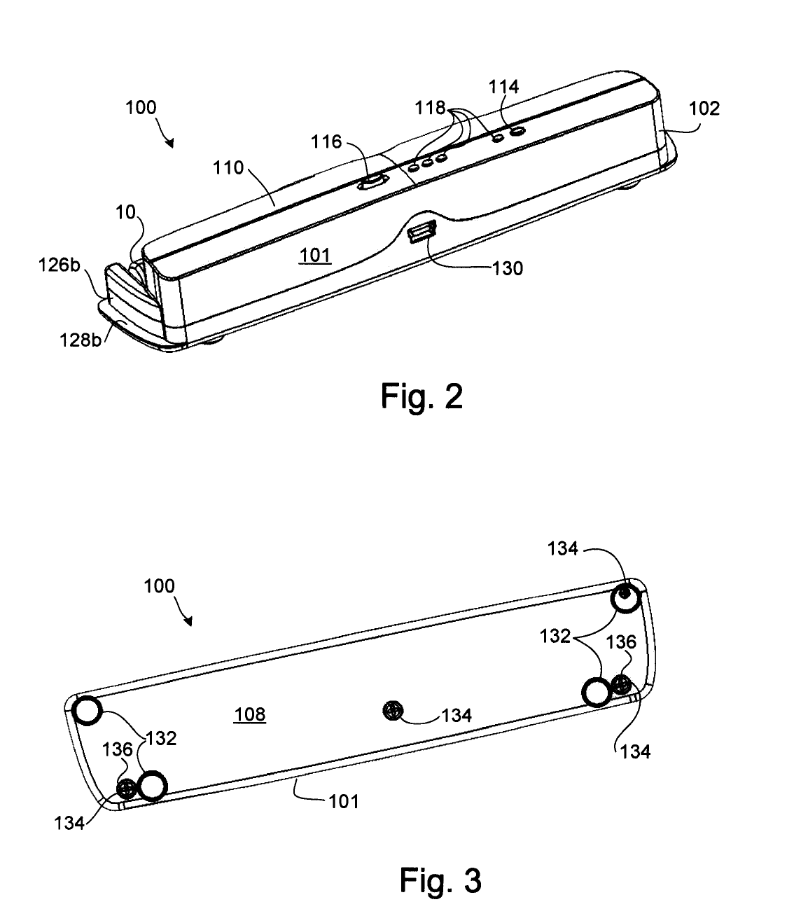

FIG. 2 is a rear isometric view of a penholder and pen.

FIG. 3 is a bottom view of a penholder.

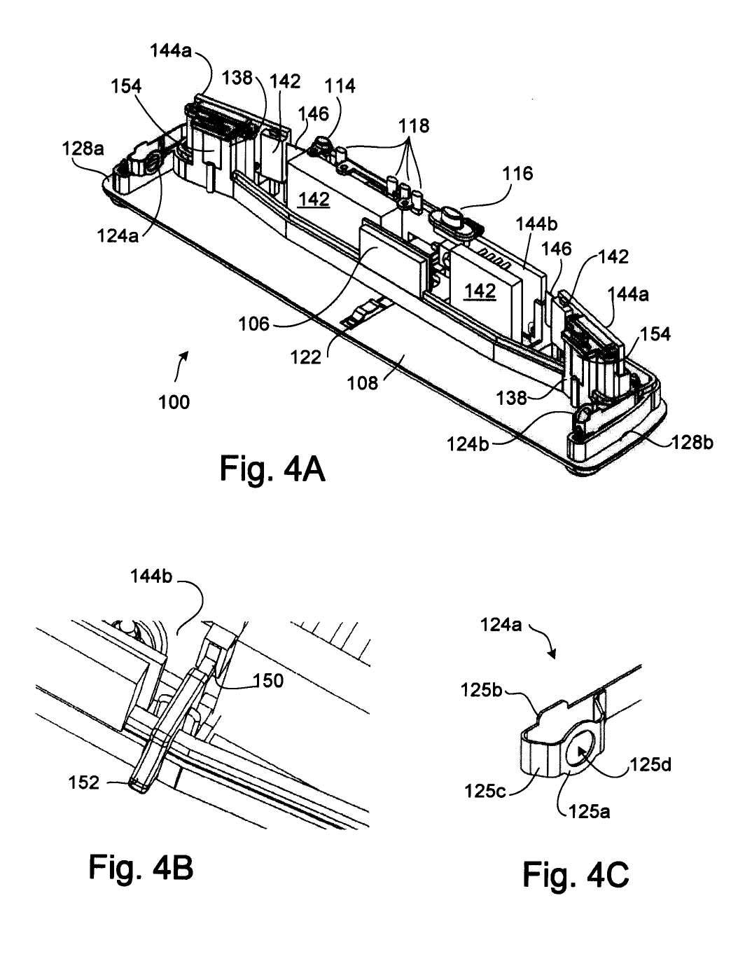

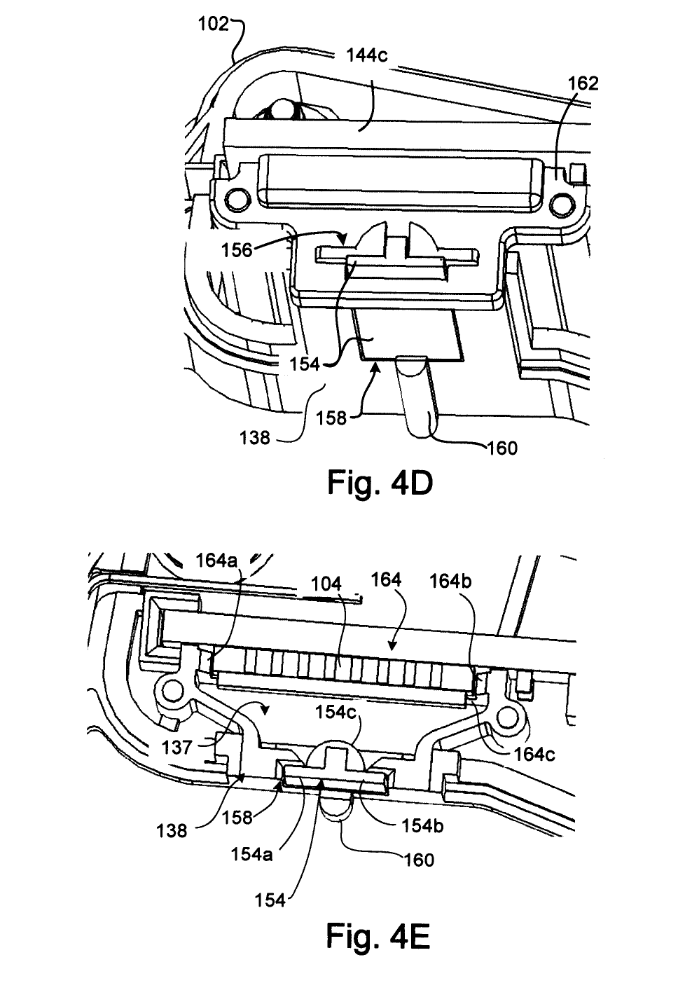

FIG. 4A is a front isometric view of internal components of a penholder.

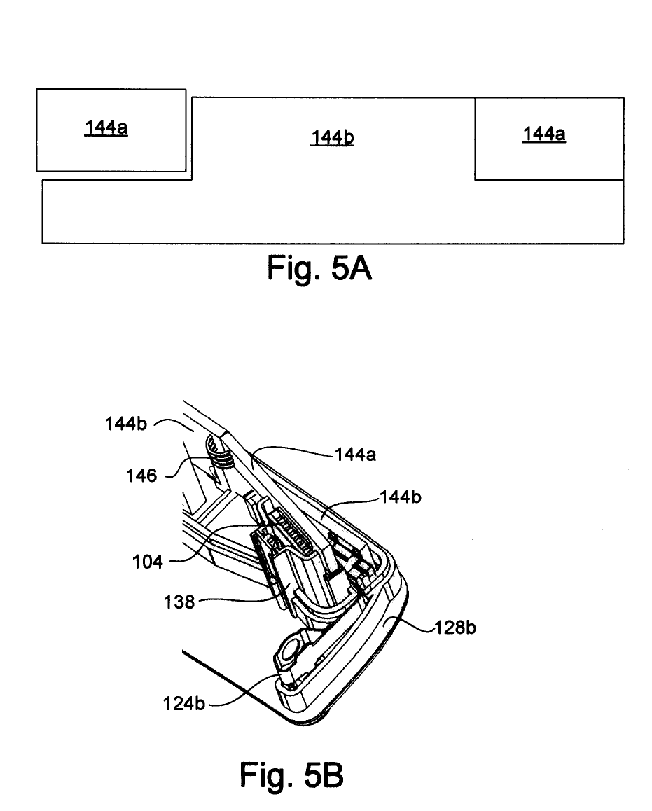

FIGS. 4B-4E and 5B are isometric views of details of internal components of a penholder.

FIG. 5A is a schematic view of a circuit board.

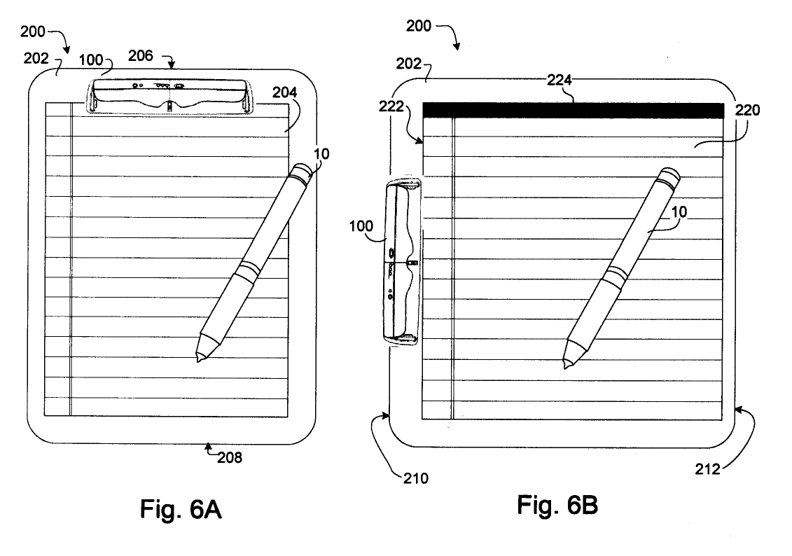

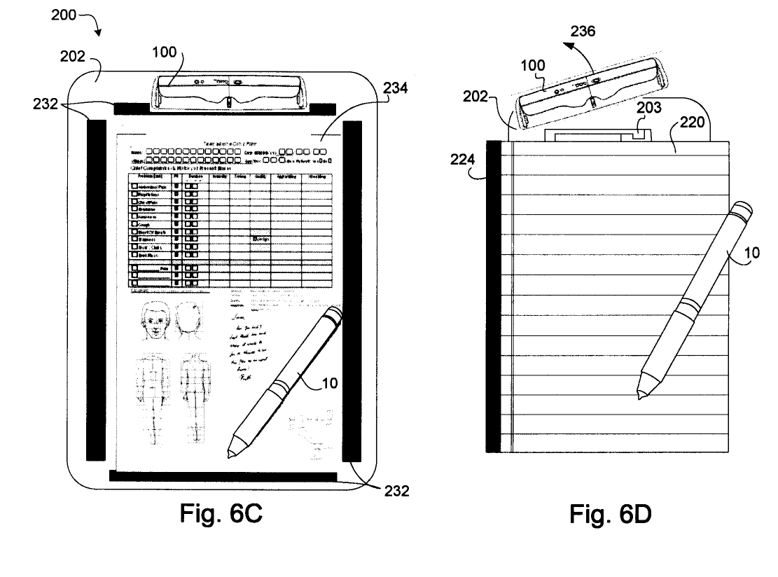

FIGS. 6A-6D are plan views of clipboards including penholders and pens.

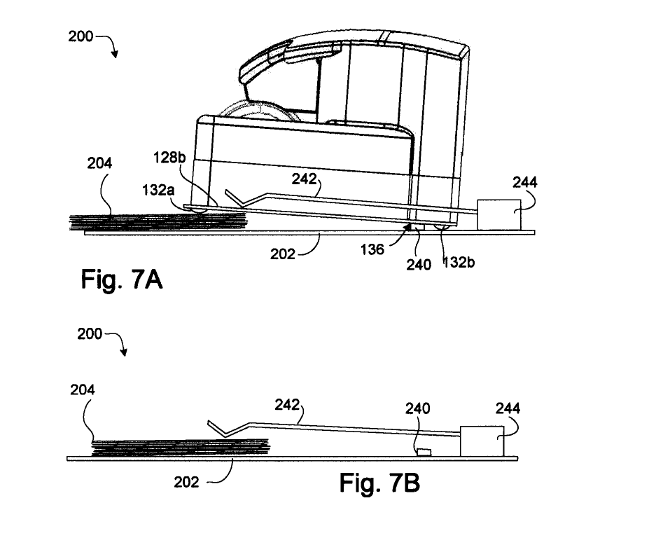

FIG. 7A is a side view of a detail of a clipboard and penholder

FIG. 7B is a side view of a detail of a clipboard.

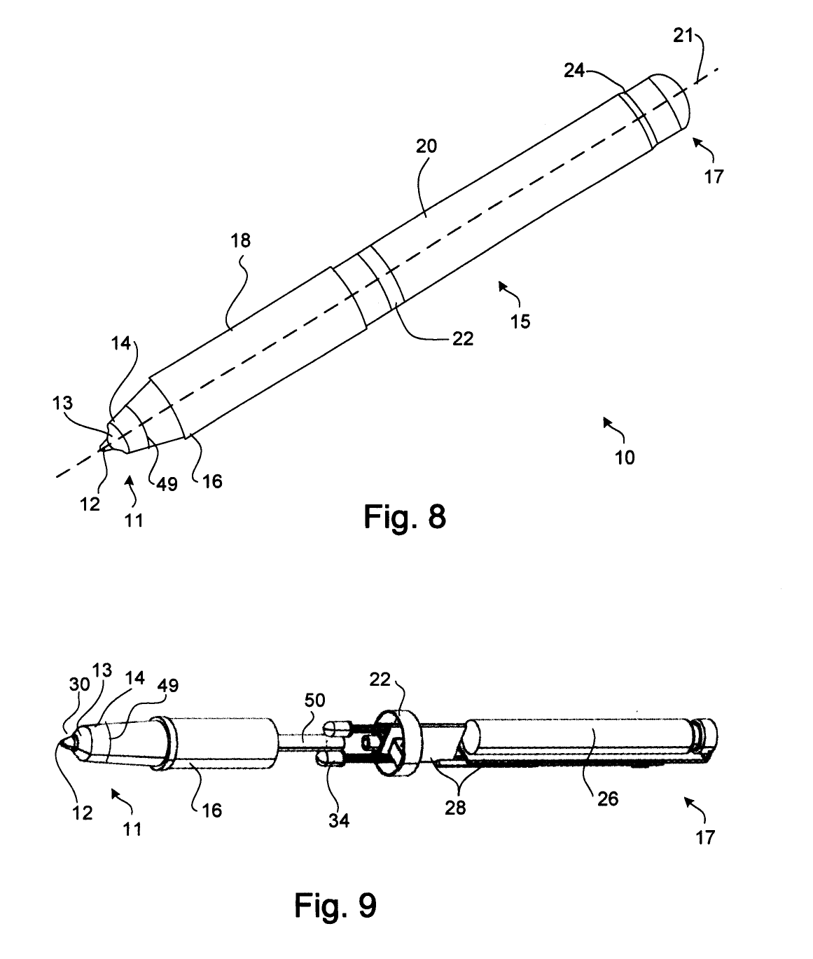

FIGS. 8 and 22 are isometric views of pens.

FIG. 9 shows components of a pen.

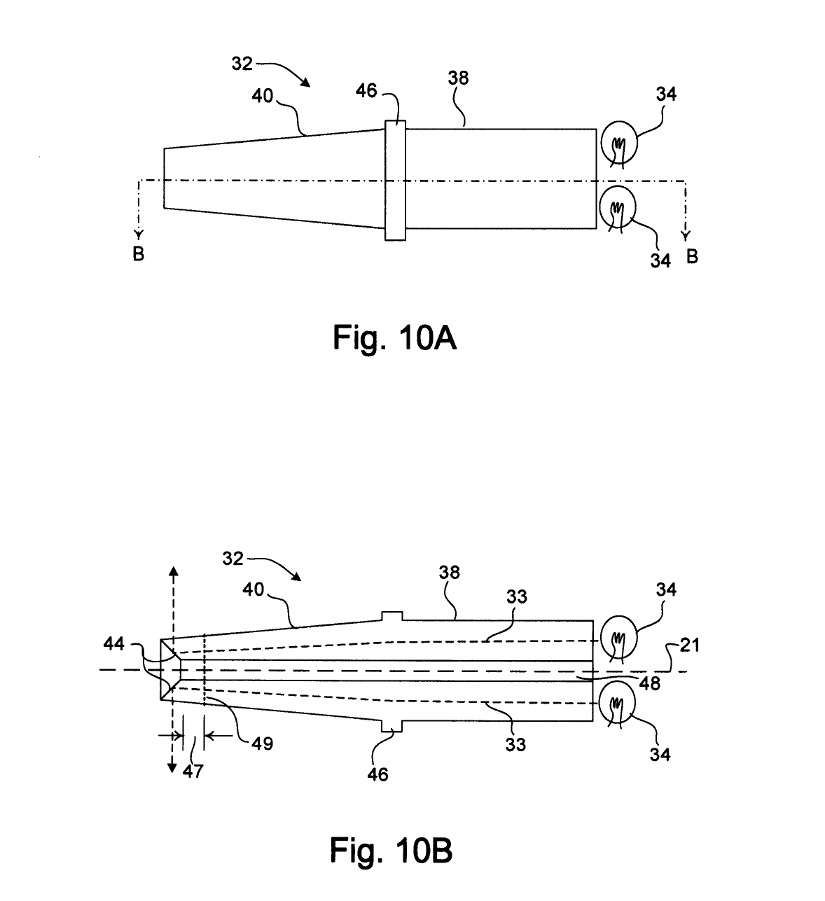

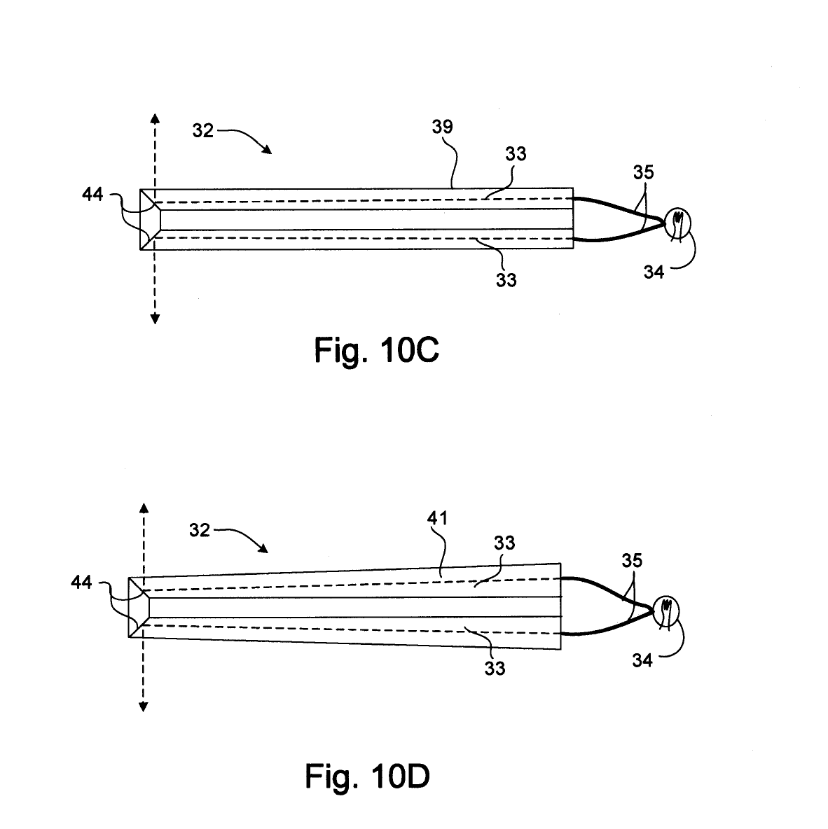

FIG. 10A is a plan view of a light guide.

FIGS. 10B-10D are cross-section views of light guides.

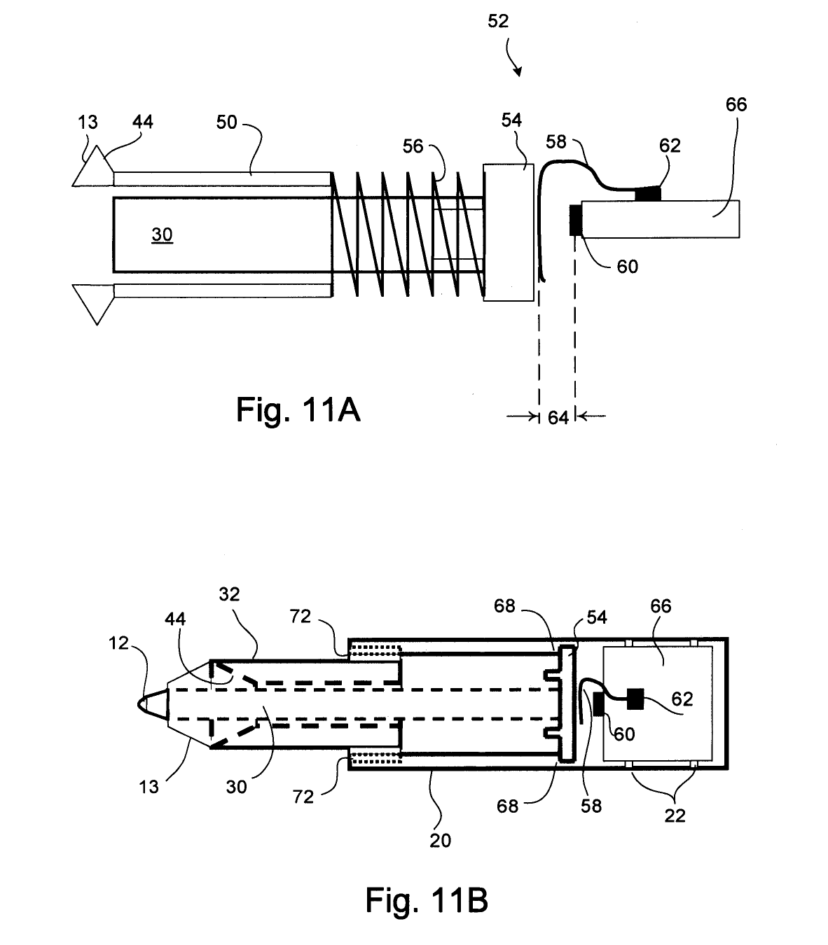

FIGS. 11A and 11B are schematic views of components of a pen.

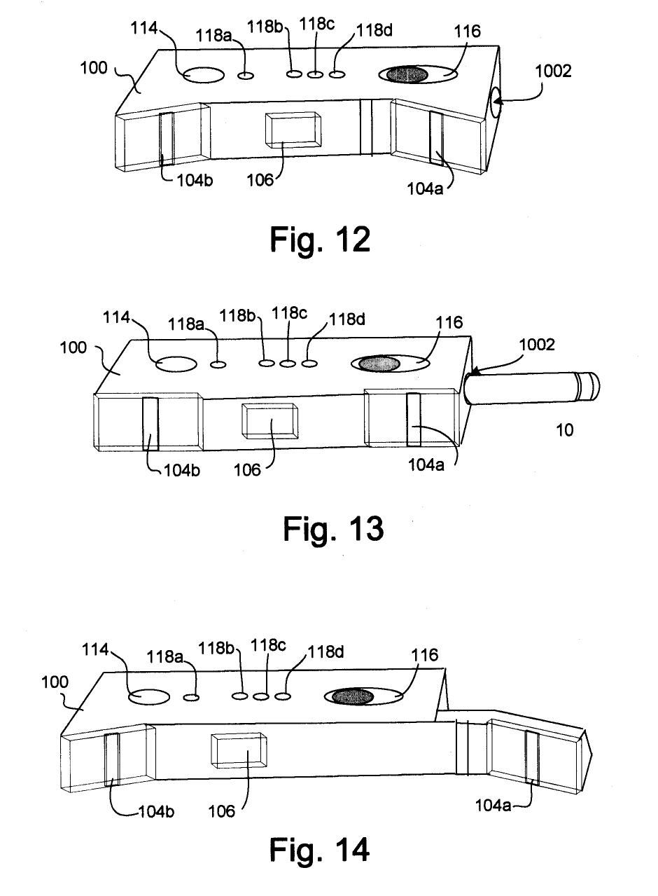

FIGS. 12, 14, 20, 23A, and 23B are front isometric views of penholders.

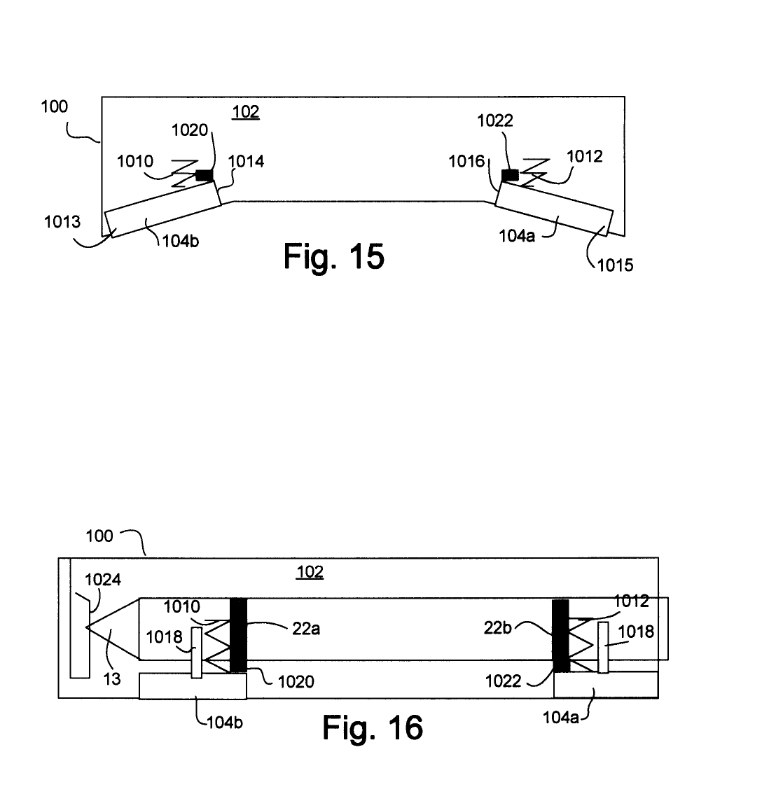

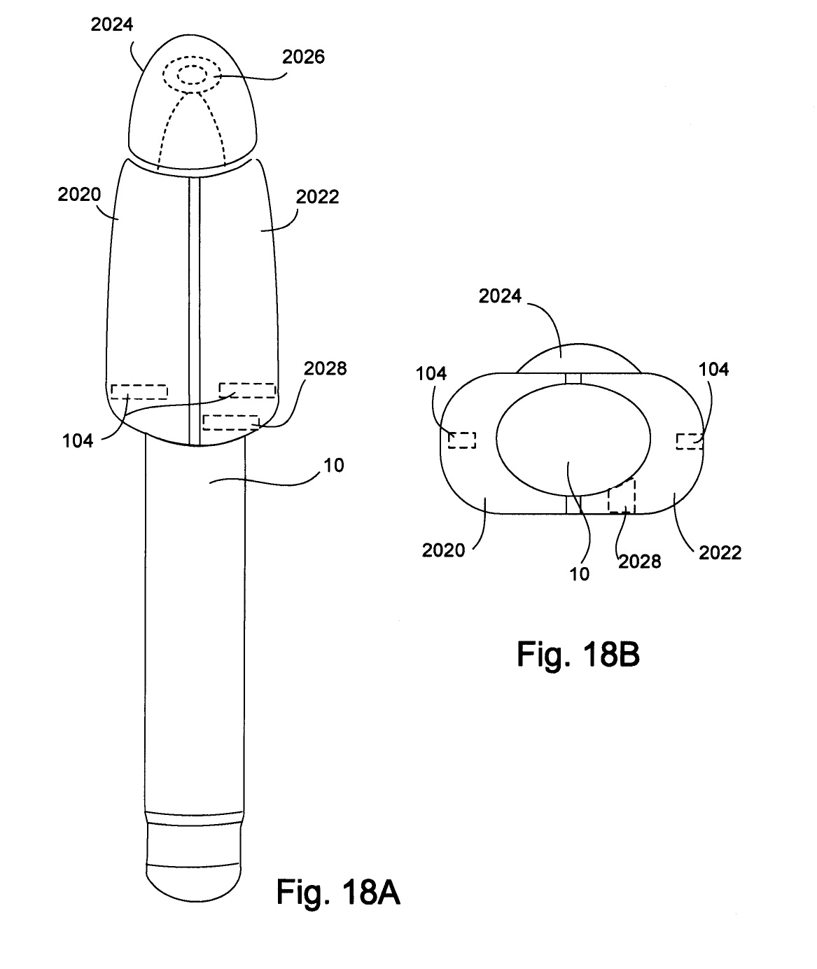

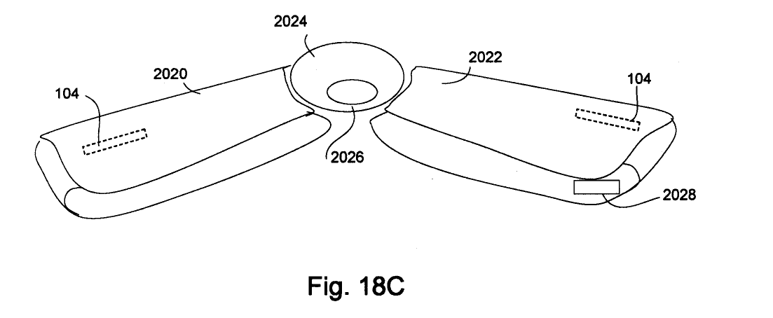

FIGS. 15 and 18C are schematic views of a penholder.

FIGS. 16, 18A-18B, and 19A-19B are schematic views of a penholder and pen.

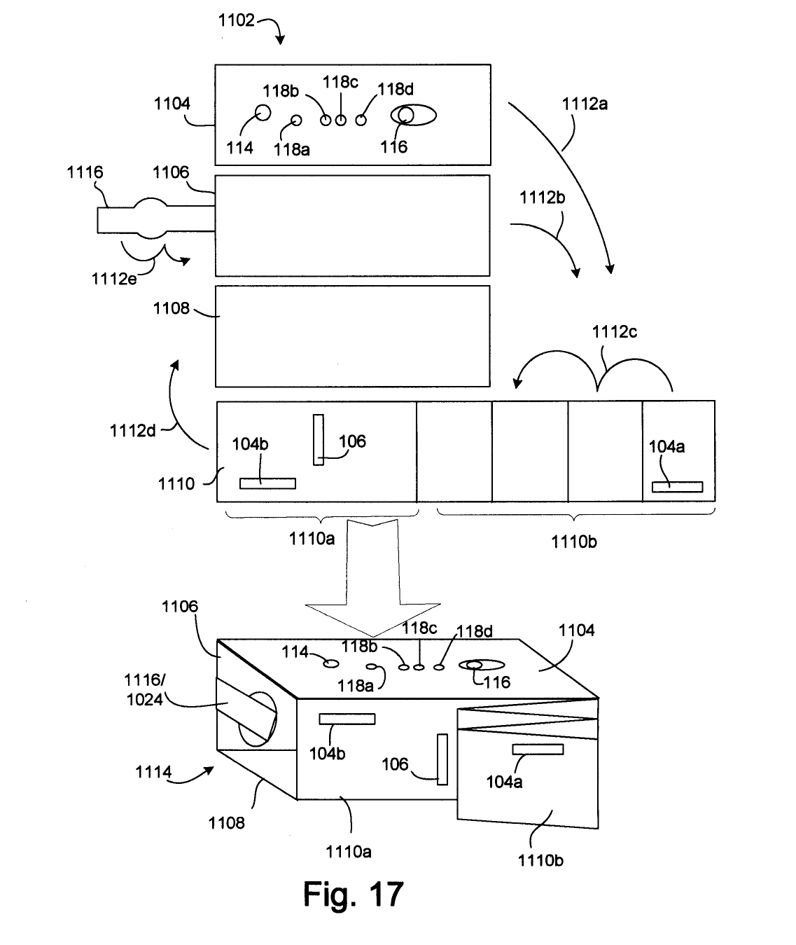

FIG. 17 is a schematic view of a circuit board.

A portable electronic device can include a pen and a holder for the pen that houses sensors to receive light emitted or reflected by the pen, for example, to determine the pen's location on a writing surface. In some examples, the device includes a clip that can be used to attach the device to a stack of paper. In some examples, the penholder is attached to a clipboard, and the entire penholder may serve as the clipboard's clip. Among other advantages, when the paper is held in the clip, the sensors have known locations relative to the paper.

In some examples, as shown in FIGS. 1A, 1B, 1C, 2, and 3, a penholder 100 includes a body 102 that houses two light sensors 104 near opposite ends 103, 105 and (in some cases) a central sensor 106 and other electronics (not shown). The body may include or be attached to a lower plate 108 and an upper plate 110. Switches 114, 116 and lights 118a-118d may also be included. A pen 10 (which may be a wireless electronic pen with or without ink, or any similar writing instrument, for example, a stylus, pencil, or marker) is housed between the lower plate 108 and upper plate 110. Flanges 110a, 110b on the upper plate 110 extend partially around the pen to shelter it and help keep it in place. Other features may be used to allow the pen to be inserted and removed along its length, and retain it against falling out in that direction. A scallop 110c between the flanges 110a, 110b allows the user's finger to be inserted beneath the upper plate 110 to grip and remove the pen 10 in direction 107. The pen 10 is also held in place by ribs 120a and 120b that project down from the underside (not shown) of the upper plate, a center spring 122 that projects up from the upper surface of the lower plate 108, and end springs 124a and 124b (see cut-away view in FIGS. 4A, 4C, 5B) in wings 126a and 126b. Details of this structure are shown in FIG. 1B, with the ribs 120a and 120b shown through the flanges 110a and 110b using dashed lines and in which the pen 10 has been removed, and in FIG. 1C, in which part of the end wing 126b has been removed to show the spring 122 from the side. In some examples, springs 124a and 124b are configured so that the pen 10 can be inserted with its tip at either end. As shown in FIG. 1C, each of the ribs 120b includes a profiled segment 121 that matches an outer surface of the pen and holds the pen firmly in place when the pen is held in the penholder 100. The lower plate 108 extends beyond the wings 126a and 126b to provide shelves 128a and 128b for attaching the penholder 100 to a clipboard, as described below.

Thus the front of the body 102, the inner sides of the two wings 126a and 126b, the upper side of the lower plate and the lower side of the upper plate define a chamber in which the pen can be stored safely when not in use. The pen can be held in place by the three springs and two ribs to permit the pen to be easily removed and replaced as needed.

A connector 130 (FIG. 2) may be located on the back 101 of the penholder 100, as shown in FIG. 2, or it may be located at either end on one of the wings 126a or 126b. The connector 130 may be a USB port or some other physical connection for transferring data and or power between the penholder 100 and an external device (not shown) such as a computer, a telephone or a PDA. Four feet 132 located on the bottom of the penholder 100 provide traction on whatever surface the penholder 100 is placed, or they may hold paper in place if the penholder 100 is used as part of the clip of a clipboard. In some examples the feet 132 are composed of a material having a greater traction than the materials from which the other parts are composed. Screws 134 may hold the lower plate, the upper plate, and the body of the penholder 100 together. In some examples, holes 136 where the screws 134 were inserted may be used to connect the penholder 100 to mounting features on a clipboard, as described below. One or more holes 136 may also be used specifically for this purpose, for example, if the plate 108 is integral to the body 102 or attached without fasteners.

In some examples, the feet 132 can be inserted into holes in a plate to create an assembly that can be retained inside a notebook without movement relative to the pages. The pages can be turned back and forth without disturbing the penholder's ability to detect the use of the pen on each page. The feet 132 can be used together with the holes 136 for screws or other features in the bottom of the penholder 100.

The positioning and function of the sensors 104 and 106 depends on the hardware and software implementation of the device. In some examples, two sensors 104 positioned respectively near the opposite ends 103, 105 of the penholder 100 detect light emitted from the pen 10, when the pen is removed from the penholder and is in use. Electronics in the penholder use the detected light to triangulate the pen's location. Other sensing technologies, such as ultrasonic emitters and detectors, may also be used. The central sensor 106 may be used, for example, to detect emissions from the pen to synchronize the timing of the operation of the end sensors 104 with a carrier signal in the light from the pen. Other information can be transmitted between pen and penholder by modulating a carrier signal, including light intensity of the emitter on the pen (which may be reduced, for example, to save battery life), the amount of battery charge left on the pen, the color of the ink cartridge being used, pressure applied to the pen, tilt of the pen, and use of an erase function. The penholder 100 may also communicate messages to the pen, for example, through an infrared emitter coupled to one of the sensors 104 or 106. This may be used for various purposes, including synchronizing timing between the penholder and the pen or signaling to the pen that there is a problem with the signals being received at the sensors 104. In some examples, the user may block one or both of the sensors due to the way he is holding the pen or turning pages, while switches in the pen (described below) indicate that the pen is in use. The penholder may signal to the pen that it is not receiving light, and the pen may illuminate a visible light to indicate that there is a problem.

In some examples, the sensor 106 is replaced by a light source and the sensors 104 detect reflections from the pen 10. Additional information about the use of the sensors in some implementations may be found in U.S. Pat. No. 6,577,299, Electronic Portable Pen Apparatus and Method, issued Jun. 10, 2003, and application Ser. No. 10/623,284, Tracking Motion of a Writing Instrument, filed Jul. 17, 2003, both incorporated here by reference.

In some examples, the springs 122, 124a, 124b may be used both to hold the pen 10 in place and to provide power to recharge a battery within the pen 10 as described below. With the spring 122 located in the center of the chamber, the pen can be inserted with its tip contacting either spring 124a or 124b, and a charging circuit can be completed in either orientation. In some examples, the electronics may detect which of springs 124a or 124b is in contact with a charging terminal on the pen 10 and provide an appropriate polarity voltage to that spring. In some examples, springs 124a and 124b may be energized with opposite polarity voltage to charge a pen 10 having contacts at both ends. Similarly, two contacts 122 may be provided to contact two electrodes along the length of the pen 10. In some examples, one or more of the springs 122, 124a, 124b may be connected to switches to detect when the pen 10 is held in the penholder 100. An additional switch may also be used, for example, a switch 150 located on a circuit board 144b and linked to a plunger 152 that protrudes into the space to be occupied by the pen, as shown in FIG. 4B. This detection may be used, for example, to turn the penholder 100 on when the pen 10 is removed and to turn it off when the pen 10 is replaced into the penholder 100. The springs 124a, 124b, may also be shaped or include additional material to cover the tip of the pen and prevent it from leaking ink or smudging its surroundings when not in use.

In some examples, the shape of the springs 124a and 124b, as shown in FIG. 4C, includes two pieces 125a and 125b joined by a bent segment 125c. The piece 125a presented to the pen 10 has a hole 125d to receive the tip of the pen and to make contact with a contact near the tip as described below. The connection should be secure but soft to assure a good electrical contact of surfaces.

The switches 114, 116 and lights 118 may have various uses. In some examples, the switch 116 is used to select one of several operating modes of the penholder 100, such as instructing the penholder to save the detected handwriting to internal memory, to transmit it over USB or some other physical connection, or to transmit it over a Bluetooth® wireless link or some other wireless system, such as WiMax® or Zigbee® wireless technology. In some examples, the switch 114 is used to turn the penholder 100 on or to indicate to the penholder 100 that a user has turned to a new page. The switch 114 may be a rocking switch that allows the user to flip up or down between pages. Pages of writing may be stored in an on-board memory or transmitted to and loaded from a related device (not shown), such as a cell phone or PDA. A screen on the related device or an indicator on the pen itself, such as one of the lights 118 or a small screen (not shown) may show the current page. Using an external display on another device that a user would have anyway can allow the user to view a previously-created page she is now editing without requiring that the penholder itself have a display, saving both power and package space. The page to be edited may be selected by the other device, based on either user input to that device or the user's current handwriting, as interpreted by that device after being communicated to it by the penholder 100. In some examples, an additional sensor (not shown) may detect that a page has been flipped, and the penholder 100 may automatically change which page it is storing input to, or it may use one or more of the lights 118 to indicate to the user that it thinks the page should be changed using the switch 114. To preserve battery life in the penholder and related devices, the wireless connection may be put in a sleep mode after the data or commands have been sent and while new pen input is being recorded.

One or more of the lights 118 may illuminate or flash to acknowledge that such a command has been received, that the penholder is ready to receive pen input, that the memory is full, that a page has been turned, or that the penholder is transmitting, among other functions. In some examples, the light 118a is amber and blinks once to indicate that the penholder is ready for the next page and blinks continuously to indicate that the internal memory is full. The light 118b is red and indicates that power is on or that the penholder is being charged. The light 118c is green and indicates that the pen is in use and writing is being received. The light 118d is blue and indicates that a data connection is in progress. Other colors and other uses for the lights are possible. The lights 118a-118d and the switches 114, 116 may be integrated, and more or fewer lights or switches may be used. Any of the functions of the switches 114, 116 and lights 118 may be performed on a related device connected to the penholder 100 through a physical or wireless connection. For example, hard or soft buttons on a cell phone may be used to select a page and input mode, and the cell phone's screen may indicate the writing being performed by the pen. Calibration data may be stored in the penholder 100 or in a device that is to receive information from the penholder about the movement of the pen. Such data may be used, for example, to correct for manufacturing variations in the sensors or other components.

The penholder 100 may contain electronics and other structures, as shown in FIGS. 4A-4E. These may include assemblies 138 to hold the sensors 104 or their components in place or to block or control light entering the sensors. The sensors 104, 106 and other circuit components 142 may be connected to circuit boards 144. The circuit boards 144 may be printed circuit boards, flex boards, or other technology. In some examples, the supports may control light in such a way that the sensors 104, 106 remain operational with the body 102 of the penholder 100 opened to allow testing or calibrating.

FIGS. 4D and 4E show the support assemblies 138. In some examples, the assemblies 138 form a chamber 137 (FIG. 4E) to control the orientation of a lens 154 relative to the sensor 104, to enable easy assembly, to block ambient and other interfering light, including light from the pen itself other then the light being focused by the lens 154, and to allow testing and calibration in a production environment.

The lens 154 is inserted into an opening 158, supported by a front lens support 160. A top cover 162 protects the sensor 104 within the assembly 138. As shown in FIG. 4E, the sensor 104 is positioned in a cradle 164 within the assembly 138 in such a way that the sensor 104 is captured between two plastic features 164a and 164b. This positions the sensor 104 relative to the lens 154 horizontally; vertically it is fixed by the bottom 164c of the cradle 164. The lens 154 is supported vertically within its opening 158. In some examples, flanges 154a and 154b on the side of the lens 154 block ambient and pen light, so that light is only admitted into the chamber 137 through the operational section 154c of the lens 154. In examples where infrared sensors are used, the lens 154 may be composed of IR-filtering material that blocks most of the ambient light. The cover 162 keeps the lens 154 and sensor 104 in place. Glue may be used to keep the lens 154, the cover 162, and other components in place. With the cover and lens blocking stray light from reaching the sensor 104, testing and calibration can be performed without risk that lens and sensor would move or that outside light will compromise readings. This can allow, for example, electronic and other troubleshooting to be performed without recalibrating the penholder electronics.

In some examples, the sensors 104 are connected to daughter boards 144a that are each positioned at an angle relative to the main circuit board 144b. In some examples, these circuit boards 144a, 144b may be cut from a single circuit board 144 after fabrication, as shown in FIG. 5A. Jumpers or cables 146 may provide electrical communication between the sensors 104 on the daughter boards 144a and the rest of the electronics 106, 142 on the main circuit board 144b, shown in detail in FIG. 5B. Other shapes and configurations are possible, depending on the packaging requirements of the penholder and the operation of the sensors.

In some examples, as shown in FIGS. 6A-C, 7A, and 7B, a clipboard 200 may be provided in which the penholder 100 is attached to a board 202. In some examples, the pen may be tethered to the board 202, and the tether may be used to provide power or data to the pen (not shown). The penholder 100 may also form the clip of the clipboard. Such a clipboard may be configured to hold a stack of paper sheets 204 either in a portrait (FIG. 6A, 6C) or a landscape (FIG. 6B) orientation. The penholder can be positioned at either the top 206 or bottom 208 of a portrait orientation and either the left side 210 or right side 212 of a landscape orientation, depending on the preference of the user. If the paper is bound in a pad 220 (FIG. 6B), the clipboard 200 may be oriented so that the penholder 100 is on an edge 222 other than the spine 224 of the pad 220, permitting the pages to be flipped without interfering with the sensors 104. In some examples, as discussed below, the sensors can be repositioned relative to each other to best accommodate the shape of the paper.

FIG. 6C shows an example of a clipboard being used for pre-printed forms. Guides 232 surround a form 234 and hold it in place, assuring that the markings on the form are in known locations relative to the penholder, so that the position of the pen 10 detected by the penholder 100 can be correlated to fields in the form. The layout of the form is also known in advance and may be stored in the memory of the penholder 100. In some examples, the penholder 100 converts the pen's positions to input on the form and transmits only the input to another device, e.g., a PC. In some examples, the penholder 100 transmits the pen's motion in an unprocessed state and the PC itself relates the motion to the contents of the form.

In some examples, as shown in FIG. 6D, the board 202 may be inserted into the pad 220, so that the penholder 100 can be easily removed (arrow 236) and the board 202 will remain inserted in to the pad 220. This way, the orientation of the sensors 104 to the pad will be the same when the penholder 100 is returned to the clipboard 200, so the user can continue writing on the same document and the penholder will know where markings have already been made on the paper from the last time it was used, thus the user may edit a single document in more than one session. This may also be accomplished by consistently placing the board 202 in the pad 220 in a specific location, for example, with the board against the binding and the penholder 100 against the edge of the pad 220. The user could then put the board 202 between different pages as he moved through the pad. In some examples, the board 202 may be made smaller, to be used more like a bookmark than a clipboard, still holding the penholder 100 in a consistent position relative to the pad 220. In some examples, the user may write directly on the board, with or without actually leaving marks, depending on the configuration of the pen.

In some examples, the clipboard 202 may include electronic circuitry 203 to complement that in the penholder 100, such as an antenna for wireless communication or sensors to detect when pages have been turned, as mentioned above, or the number of pages between the penholder 100 and the board 202. A use may be prompted to change pages when the number of pages changes. The penholder 100 may communicate to another devise to display a new page when the page is changed.

FIG. 7A shows details of how the penholder 100 may be secured to the clipboard 200. As noted above, the holes 136 on the bottom of the penholder 100 may receive a mounting feature 240 attached to the board 202. Alternatively, the feet 132 may be inserted into holes in the board 202 (not shown). In some examples, a spring 242 may be attached to the board 202 via a mounting block 244. In some examples, the spring 242 may be an extension of the board 202 or directly fastened to the board, e.g., by a rivet or screw. This spring 242 may press down on the penholder 100 via the shelves 128a and 128b, also as mentioned above. Such an arrangement may allow the penholder 100 to pivot upward to accommodate the paper 204. In some examples, the front foot 132a may help hold the paper in place. In some examples, the rear foot 132b may provide a point for the penholder 100 to rock on, or may limit its range of motion. In some examples, the spring 242 or its mounting block 244 may hold the paper in place independently of the penholder 100, as shown in FIG. 7B.

In some examples, the pen is constructed as shown in FIGS. 8 and 9. FIG. 8 shows the exterior of the pen and FIG. 9 shows internal components with the pen body 20 absent. The writing end 11 of the pen 10 has a writing tip 12, a front face 13, light source 14, a forward body 16, and a grip 18. The middle 15 of the pen has a main body 20 and a charging contact 22 and houses electronics 28. In some examples, the charging contact is a band around the entire circumference of the body 20 so that it will make contact with the center spring 122 of the penholder 100 described above regardless of the pen's rotation about its long axis 21. A second contact may be located at the front face 13 at the writing end 11 of the pen. As noted above, there could be two or more charging contacts 22 to contact two or more springs 122 or other electrical contacts. One or more of the charging contacts may be integrated with a retaining feature to hold the pen within the penholder. An advantage of charging through the front face 13 and a single center contact 22 is that is allows a conventional pen appearance, with only one metal ring contact on the body of the pen where most pens have a band to hide a joint between two parts of the body. Thus the center contact 22 serves the conventional function of joining two parts of the pen, and the front face 13 may be made indistinguishable from other pen's tips. Placing the ring contact into the center of the pen also has the advantage of allowing the pen to be inserted into the penholder 100 in either direction, convenient for serving both right- and left-handed users.

The tail end 17 of the pen 10 has a rear body 24 that houses a battery 26. The writing tip 12 may be part of a pen cartridge 30, such as a refillable or disposable ink cartridge. The pen 10 may include a pen guide 50 to provide an electrical pathway from the electronics 28 to the front face 13. The light source 14 may be a lamp 34, such as one or more LEDs, or a reflector. In some examples, the light source 14 is an end of a light guide 32 as shown in FIGS. 10A and 10B that guides light 33 from lamps 34 deeper within the pen body. Additional information about examples of pens may be found in patent application Ser. No. 10/623,284 cited above.

The light guide 32 may include a straight section 38 that receives light 33 (short-dashed line) from the lamps 34, and a tapered section 40, that exits the pen body and emits light. The lamps 34 may be molded into the light guide 32 or may be separate from it. The tapered section 40 may include a reflector, such as reflective surface 44, configured so that light is emitted at an angle selected to increase the amount of light that will reach the sensors 104. The reflector have various forms, including a distinct component, a polished face of the light guide 32, or a coating on a face of the light guide. In some examples, the surface 44 defines a conical frustum having a smaller diameter matching a channel 48 through the center of the light guide along the axis 21. In some examples, the conical frustum has an angle of 45 degrees from the axis 21 so that light 33 is reflected approximately perpendicular to the axis 21. The reflective surface 44 may begin a distance 47 from the position 49 at which the light guide 32 exits the pen body (see FIG. 8) to assure that light 33 has room to diverge after leaving the light guide 32. In some examples, this distance 47 is about 1.0 mm. A ridge 46 may be included to attach the light guide 32 to the forward body 16. The channel 48 guides the pen cartridge 30 and may include space for a pen guide 50 described below. The outside diameter of the straight section 38 may be close to the inside diameter of the pen body 20 to assure that the pen cartridge 30 can be inserted through the center of the pen body 20 and light guide 32 without hitting the lamps 34 or other electronic components.

The tapered section shown in FIGS. 10A and 10B can reduce the efficiency with which light is conducted from the lamps 34 to the reflector 44. This effect can be reduced by making the straight section 38 close in diameter to the outside diameter of the reflector 44, i.e., making the entire light guide cylindrical or nearly so, as shown in FIG. 10C. In the example of FIG. 10C, the light guide 32 has a single cylindrical section 39. In the example of FIG. 10D, the light guide 32 has a single tapered section 41. To accommodate a smaller diameter at the lamp end of the section 39, smaller LEDs may be used for lamps 34, or the lamps 34 may be connected to the light guide 32 by fiber optic guides 35. The LEDs may be mounted directly on the surface of a circuit board. In some examples, the diameter of the light guide is around 4 mm. In some examples, the light guide has a diameter of around 7 mm at the end coupled to the lights 34 and around 4-5 mm at the end where the light 33 exits.

As the light 33 moves from the fiber 35 to the reflector 44, the light guide mixes it to encourage a uniform distribution of light at the tip. To help maintain high efficiency, the surfaces of the light guide 32 should be protected from scratches and direct contact with foreign materials, especially those with a high coefficient of refraction, which may absorb light and prevent the light guide 32 from channeling it to the reflector 44. The pen body 20 can provide this protection for the outer surface, and the pen guide 50 may be used to protect the inner surface of the channel 48. In some example, surfaces of the light guide may be coated with an aluminum paint or other reflective material, which may also serve to enhance reflection and provide electrical conductivity in addition to protecting the surfaces.

In some examples, the lamps 34 may include LEDs or other light sources that emit light in more than one frequency. Infrared may be used for communicating with the sensors 104 and 106 in the penholder 100, while visible frequencies are used to communicate with the user, for example, using different colors to indicate the pen's status or battery charge.

FIG. 11A shows a switch mechanism 52 that detects when the pen 10 is in use. The cartridge 30 extends through a guide 50 and ends in an end cap 54. At the end of the guide 50 it expands to form both the reflector 44 for the light guide and the front face 13 of the pen (the length and width are not to scale in FIG. 11A and other figures). In some examples, the guide 50 is integral to the light guide 32 or some other body structure of the pen 10. A coil spring 56 provides pressure between the end cap 54 and the guide 50. This keeps the end cap 54 in contact with a flat spring 58. The flat spring 58, in an equilibrium position, maintains a small gap 64 between itself and a contact pad 60 on a circuit board 66. The flat spring 58 is also in contact with a second contact 62. When the pen is in use, the pressure of writing presses back on the pen cartridge 30, deflecting the flat spring 58 and causing it to contact the pad 60. This completes a circuit between the contact pad 60 and the second contact 62, indicating to the pen's circuitry (not shown) that the pen is in use. To avoid interfering with the writing of the pen, the gap 64 between the flat spring 58 and contact pad 60 may be on the order of 0.2 mm. The springs 56 and 58 together may be configured to allow this small movement with a force sufficiently small that a user will not notice the movement or the force required to achieve it. Other methods of sensing that pressure is being applied to the pen cartridge 30 may also be used. In some examples, the end cap 54, coil spring 56, and guide 50 may all be conductive to provide a current path, including the flat spring 58, from the pad 62 to the front face 13 of the pen to route power from one of the springs 124a or 124b to charge the battery 26 in combination with the charging contact 22 at the center of the pen.

In some examples, the pen 10 is structured as shown in FIG. 11B. The end cap 54 is sized to occupy the entire diameter of the pen body 20. A lip 68 retains the end cap within the pen body 20. The pen cartridge 30 directly plugs into the end cap 54, avoiding the need to attach an end cap to the cartridge before installing it in the pen. The spring 58 maintains tension against the end cap, so that the spring 58 can work in the same manner as in FIG. 11A. In this example, no circuit is made through the front face 13, which may be made of plastic. The pen may be charged using two contacts 22 or a second contact may be located at the tail end of the pen (not shown). The pen body 20 may be connected directly to the light guide 32 using threads 72, with surfaces of the light guide coated with a suitable material, such as aluminum paint or other protective materials. Aluminum paint may serve to enhance internal reflection by the faces of the light guide and to lessen the effects of scratches on the reflection. This construction may more readily work with off-the-shelf pen cartridges.

In some examples, as shown in FIGS. 12-16, the penholder 100 is configured to be used as a cap for the pen 10, thus the pen is inserted into a channel 1002 in the body of the penholder 100. In some examples, the sensors 104 and the circuit boards that support them are mounted so that they can pivot between positions, as described below.

As shown in FIG. 12, when the pen 10 is removed, the sensors 104 pivot into the body 102 so that they are positioned at an angle that improves the accuracy of their measurements. As shown in FIG. 13, when the pen is inserted into the channel 1002, the sensors 104 are pushed out into a flat position. In some examples, the sensors move in the opposite direction, such that when the pen 10 is removed, the sensors 104 extend out from the body 102, and when the pen is inserted into the channel 1002, the sensors 104 are pulled back into their unextended position.

As shown in FIG. 14, one of the sensors 104a and surrounding packaging may also extend along the length of the penholder 100 in order to give the two sensors 104a and 104b greater separation which in turn allow for higher accuracy in the overall reading of the pen's position. In some examples, the entire penholder body may extend. This may allow the sensors to be placed in different locations or relative angular orientations according to the shape or orientation of the paper being written on.

In some examples, the moving sensors 104 of FIGS. 12 and 13 may be implemented as shown in FIGS. 15 and 16. When the pen is absent (FIG. 15), springs 1010 and 1012 push the outer ends 1013, 1015 of the sensors 104 out from or pull the inner ends 1014, 1016 in to the body 102. When the pen is present (FIG. 16), it pushes a linkage 1018 that pulls or pushes the ends 1014, 1016 back to a flat position. The movable sensors may also be used to position charging contacts 1020 and 1022 in contact with charging contacts 22a and 22b on the pen 10. In some examples, only one charging contact 22 is present along the length of the pen, with the second charging contact of the pen 10 located at the front face 13 of the pen 10 as above and a second charging contact 1024 of the penholder 100 located deep inside the channel 1002. This contact 1024 could be constructed in the same manner as the springs 124a and 124b, shown in FIG. 4C.

In some examples, circuit elements may be mounted to a flexible board 1102 that is folded into shape as shown in FIG. 17. In some examples, the board 1102 has four portions corresponding to the top 1104, rear face 1106, bottom 1108, and front face 1110 of the penholder 100. They are folded as shown by arrows 1112a-1112e to form a box 1114. In some examples, the front face portion 1110 may be longer than the others so that the part 1110b holding the sensor 104a may be extended as shown in FIG. 14. When not extended, the longer part 1110b of the face portion 1110 may be folded as shown, partially overlapping the shorter part 1110a. One of the faces may include an extension 1116 that can be folded to form the internal end contact 1024. More or fewer sections could be used, for example, the bottom section 1108 could be eliminated if no circuitry is needed on the bottom of the penholder, or additional sections may allow more complex shapes.

As shown in FIGS. 18A-18C, the penholder 100 may be in the form of a pen cap as in FIGS. 12-14, but may be configured to unfold in two sections 2020 and 2022, joined by a center section 2024, when the pen 10 is removed. The two sections 2020 and 2022 would fold back into a pen cap configuration when the pen 10 is reinserted into the center section 2024. The sensors 104 could be located in the sections 2020 and 2022, and the sections configured to place the sensors 104 at the proper positions when unfolded. The pen 10 may be charged through a first charging contact 2026 located in the center section 2024 and a second charging contact 2028 located in one of the side sections, e.g., section 2020.

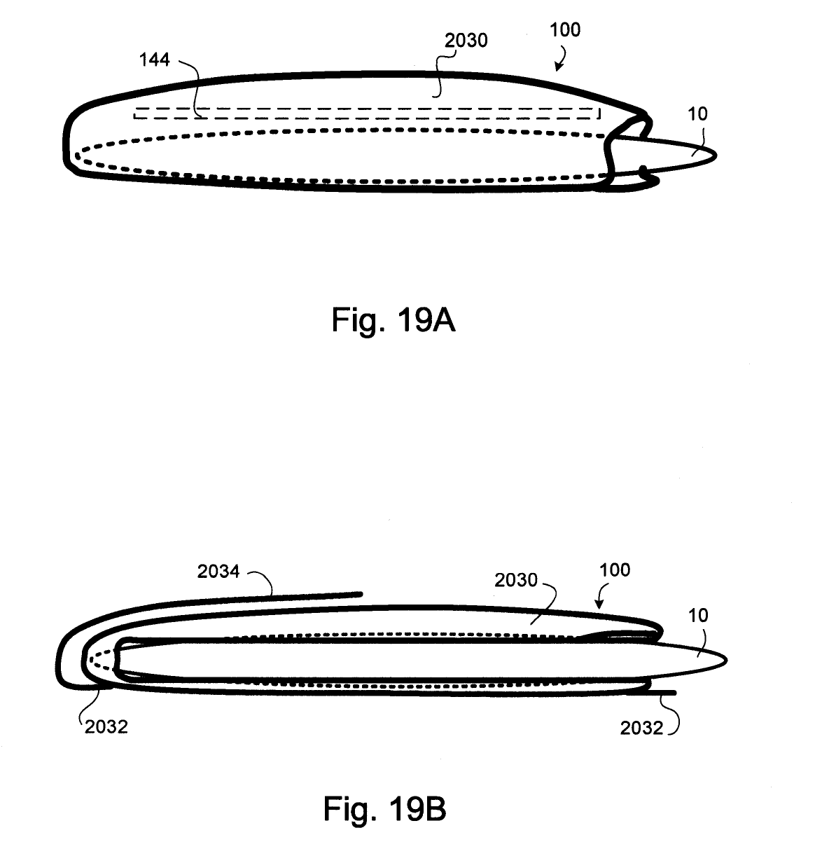

As shown in FIGS. 19A and 19B, a more compact penholder design may be used, in which the circuit board 144 is moved closer to the pen 10, allowing the outer shell 2030 to be reduced in size relative to the penholder body 102 described above. This may, for example, allow the penholder to itself resemble a large pen that can be unobtrusively carried in a user's pocket. Internal components such as the charging contact 1024 may still function as above, modified as needed to accommodate the repositioned circuit board 144. The penholder 100 in this example may include any of the features described above, for example, structures 2032 for attaching to a pad of paper or to the board of a clipboard or bookmark while a clip 2034 is used in the manner of a pocket clip in a standard pen.

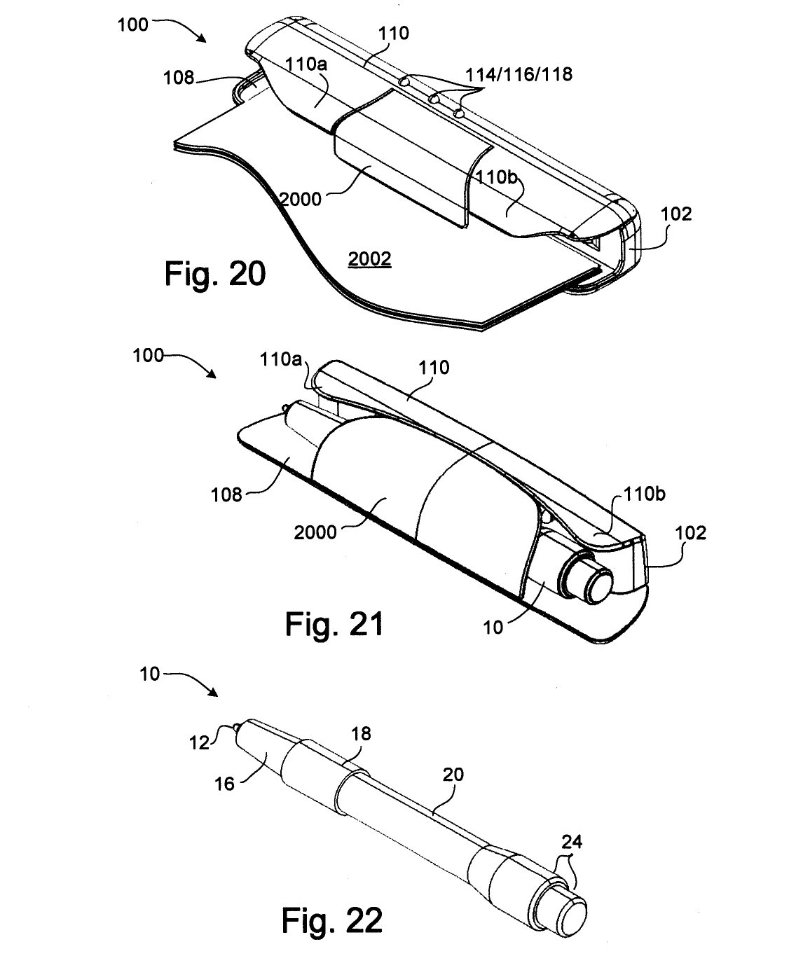

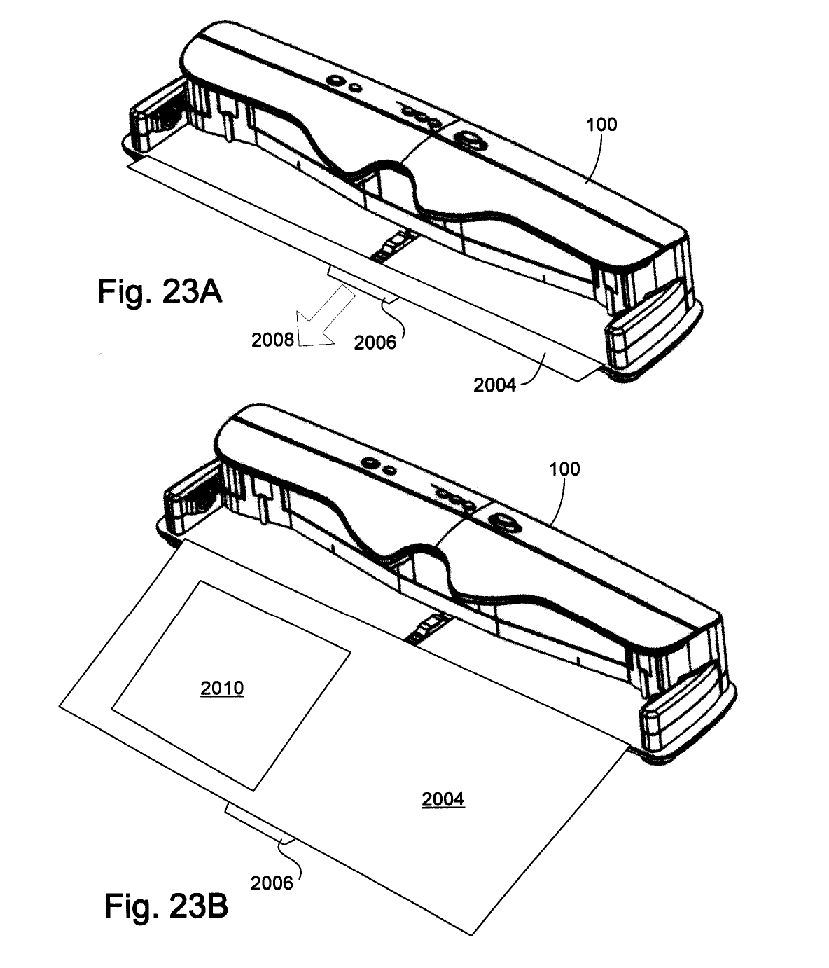

Other embodiments are within the scope of the following claims. For example, as shown in FIGS. 20 and 21, the penholder 100 may have a wide variety of other shapes. A clip 2000 can be provided that opens to release the pen and can be used to attach the penholder 100 to a stack of paper 2002. In some examples, the clip 2000 may be of a material transparent to IR light so that it does not obstruct signals from the pen 10 to the sensors 104, 106. The pen 10 may also have a wide variety of shapes including the one shown in FIG. 22. As shown in FIGS. 23A and 23B, the penholder 100 may include a retractable writing surface 2004 that is pulled out from the penholder 100 by a tab 2006 (arrow 2008), which may be a reusable writing surface or may accommodate small pieces of paper 2010. Although the examples discussed earlier include sensors in a penholder that can also serve as a clip of a clipboard, the sensing device could serve as a clip without also holding the pen. Although we have referred to a pen in much of the earlier discussion, many of the features apply to other kinds of writing instruments and styli.

What is claimed is:

1. An apparatus comprising:
a housing containing electronics used in determining locations of a writing instrument based on wireless signals,
the housing defining a chamber in which the writing instrument may be held when not in use, and
the housing including a retention element to retain the writing instrument from falling out of the chamber.

2. The apparatus of claim 1 in which the retention element is configured to retain the writing instrument in a direction normal to its length.

3. The apparatus of claim 1 in which the retention element is configured to retain the writing instrument in a direction parallel to its length.

4. The apparatus of claim 1 in which the chamber is defined by lower and upper plates extending beyond a body of the housing.

5. The apparatus of claim 4 in which the upper plate comprises two portions separated by a void.

6. The apparatus of claim 4 in which the extent of the upper plate beyond the body defines a void.

7. The apparatus of claim 6 also comprising a center spring extending from the lower plate toward the void.

8. The apparatus of claim 4 in which the extent of the lower plate beyond the body defines a void.

9. The apparatus of claim 8 also comprising a center spring extending from the upper plate toward the void.

10. The apparatus of claim 8 also comprising a rib extending from the lower plate toward the upper plate.

11. The apparatus of claim 1 also comprising a circuit to provide power to the writing instrument.

12. The apparatus of claim 11 in which the circuit to provide power to the writing instrument comprises a center spring and at least one other contact.

13. The apparatus of claim 6 also comprising a rib extending from the upper plate toward the lower plate.

14. The apparatus of claim 13 also comprising a center spring extending from the lower plate toward the void.

15. The apparatus of claim 14 in which the center spring and the rib are configured to releasably hold the writing instrument between them.

16. The apparatus of claim 1 in which the chamber is defined by a first end unit and a second end unit extending from first and second ends of a body of the housing.

17. The apparatus of claim 16 in which the first and second end units each contain a resilient structure, in which the resilient structures define a space between them within which the writing instrument may be held such that one of the resilient structures presses on one end of the writing instrument and the other resilient structure presses on the other end of the writing instrument.

18. The apparatus of claim 1 also comprising a switch to be triggered when the writing instrument is present in the chamber.

19. The apparatus of claim 1 also comprising a switch to be triggered when the writing instrument is removed from the chamber.

20. The apparatus of claim 1 also comprising sensors located near openings in the housing.

21. The apparatus of claim 20 also comprising lenses located in the openings, in which the housing comprises a first section and a second section, the first section defines the openings, and the second section can be removed from the first section without compromising the operation of the sensors.

22. The apparatus of claim 1 also comprising a button for receiving user input.

23. The apparatus of claim 1 also comprising a status indicator.

24. The apparatus of claim 1 also comprising a wireless communications interface.

25. The apparatus of claim 1 also comprising an electronic communications interface.

26. The apparatus of claim 25 in which the electronic communications interface is located on a face of the housing opposite the chamber.

27. The apparatus of claim 25 in which the communications interface is located on an end face of the housing.

28. The apparatus of claim 1 also comprising a foot attached to a bottom surface of the housing and having a higher traction than a material of which the bottom surface is composed.

29. The apparatus of claim 1 also comprising a board adapted to connect to the housing.

30. The apparatus of claim 29 in which the board includes protrusions to be inserted into holes in the housing.

31. The apparatus of claim 29 in which the board includes holes to accommodate protrusions on the housing.

32. The apparatus of claim 29 in which
the board includes springs adapted to apply pressure to the housing to maintain pressure between a surface of the housing and the board.

33. The apparatus of claim 32 in which the springs are adapted to apply pressure to the housing through tabs extending from first and second ends of the housing.

34. The apparatus of claim 32 in which the housing, the board, and the springs are adapted to hold paper between the housing and the board.

35. The apparatus of claim 29 in which the board also includes an edge boundary to position the sheet of paper relative to the housing when the housing is connected to the board.

36. The apparatus of claim 29 in which the board is sized to accommodate a letter sized sheet of paper in either a landscape orientation or a portrait orientation relative to the housing.

37. The apparatus of claim 29 in which the board is sized to be inserted into a pad of paper.

38. The apparatus of claim 37 in which the board is configured to position the housing at the top or bottom of a pad of paper that is bound along one side.

39. The apparatus of claim 37 in which the board is configured to position the housing at either side of a pad of paper that is bound along its top edge.

40. The apparatus of claim 29 in which the board is adapted to connect to the housing in a position such that sheets of paper in a pad on the board can be flipped without blocking sensors included in the housing.

41. The apparatus of claim 1 in which the housing encloses a circuit board having a first section, a second section, and a third section.

42. The apparatus of claim 41 in which the first section includes communication circuitry and the second and third sections include sensor circuitry.

43. The apparatus of claim 42 in which the first section also includes a processor.

44. The apparatus of claim 41 in which the second and third sections are not coplanar with the first section.

45. The apparatus of claim 1 also comprising a writing surface attached to the housing.

46. An apparatus comprising
a housing defining a chamber in which a writing instrument is held when not in use,
the housing being configured to be part of a clipboard structure for holding paper that is to be written on using the writing instrument,
the housing being configured to communicate wirelessly with the writing instrument to determine locations of the writing instrument when the writing instrument is used to write on the paper.

47. An apparatus comprising:
an elongate pen body,
a first electrical contact on a surface of the pen body,
a writing tip disposed at an end of the pen body, and
a light source disposed near the writing tip.

48. The apparatus of claim 47 in which the pen body includes electronics for generating light.

49. The apparatus of claim 47 also comprising a second electrical contact disposed near the writing tip.

50. The apparatus of claim 49 in which the first and second electrical contacts are adapted to receive power to charge a power supply.

51. The apparatus of claim 50 in which electronics in the pen are adapted to detect a polarity of power at each contact and provide power of a first polarity from one of the first contact and the second contact to the power supply, and to provide power of a second polarity from the other contact to the power supply.

52. The apparatus of claim 47 in which the first electrical contact extends over a circumference of the pen.

53. The apparatus of claim 47 in which the light source comprises a light guide to direct light from an illumination source within the pen body to a location outside the apparatus.

54. The apparatus of claim 53 in which the illumination source comprises two or more LEDs and the light guide is configured to mix light from the LEDs into a uniform illumination field.

55. The apparatus of claim 54 in which the illumination field extends 360 degrees around the apparatus.

56. The apparatus of claim 53 in which the light guide comprises a tapered section having a first end of a first diameter and a second end of a second diameter.

57. The apparatus of claim 56 in which the light guide also comprises a section having a uniform cross section of the first diameter and coupled to the tapered section at the first end of the tapered section.

58. The apparatus of claim 53 in which the light guide comprises a reflective surface to cause light conducted through the light guide to exit through an outer surface of the light guide.

59. The apparatus of claim 58 in which the reflective surface comprises a second electrical contact.

60. The apparatus of claim 58 in which the reflective surface defines a conical frustum having an angle of 45°.

61. The apparatus of claim 60 in which a narrow end of the conical section is located about 1 mm from the end of the pen body.

62. The apparatus of claim 53 in which the light guide comprises a channel to accommodate a writing implement through an axis of the light guide.

63. The apparatus of claim 62 in which the writing implement comprises a pen refill cartridge.

64. The apparatus of claim 53 in which the channel is configured to control the position of the pen cartridge.

65. The apparatus of claim 47 in which the writing tip comprises a tip of a pen cartridge located within the pen body.

66. The apparatus of claim 47 in which the pen body also includes a guide member for receiving a pen cartridge.

67. The apparatus of claim 66 also comprising a coil spring, an end cap, a flat spring, and a second contact near the writing tip, in which the second contact, the guide member, the coil spring, the end cap, and the flat spring are each electrically conductive and together form a complete circuit path from the second contact to a circuit contact.

68. The apparatus of claim 47 also comprising an end cap disposed within the pen body and arranged to be connected to a pen cartridge.

69. The apparatus of claim 47 also comprising a grip disposed between the first electrical contact and the light source.

70. The apparatus of claim 47 also comprising a switch to be triggered when pressure is applied to the writing tip.

71. The apparatus of claim 70 in which the switch comprises a first switch contact, a second switch contact, a switch spring, and a mechanical linkage from the writing tip to the switch spring, such that when pressure is applied to the writing tip, the mechanical linkage causes the switch spring to complete a circuit between the first and second switch contacts, and when pressure is not applied to the writing tip, the switch spring breaks the circuit.

72. The apparatus of claim 70 in which when pressure is not applied to the writing tip, there is a gap of around 0.2 mm between the switch spring and one or the first and second switch contacts.

73. A method comprising:
attaching a sensing device to a clipboard,
attaching paper to the clipboard,
writing on the paper using a writing instrument coupled to the sensing device, and
generating at the sensing device a record of the writing of the writing instrument.

74. The method of claim 73 in which the writing instrument is coupled to the sensing device through a wireless communications link.

75. The method of claim 73 in which generating the record comprises storing raw data representing movement of the writing instrument.

76. The method of claim 73 in which generating the record comprises applying calibration parameters to adjust raw data and storing adjusted data representing movement of the writing instrument.

77. A method comprising:
positioning a sensing device in a known location relative to a pre-printed form,
writing on the form using a writing instrument wirelessly coupled to the sensing device,
generating a record of the writing of the writing instrument, and
associating the record with fields on the form.

78. An apparatus comprising:
a housing containing electronics used in determining locations of a writing instrument based on wireless signals,
the housing defining a chamber in which the writing instrument may be held when not in use, and
a switch to be triggered when the writing instrument is present in the chamber.

79. An apparatus comprising:
a housing containing electronics used in determining locations of a writing instrument based on wireless signals,
the housing defining a chamber in which the writing instrument may be held when not in use,
the electronics including electrical contacts, such that when the writing instrument is present in the chamber, the contacts will couple to contacts on the writing instrument and provide power to the writing instrument.

80. An apparatus comprising:
a housing containing electronics used in determining locations of a writing instrument based on wireless signals,
the housing defining a chamber in which the writing instrument may be held when not in use,
the electronics including three electrical contacts, such that when the writing instrument is present in the chamber, at least two of the contacts will couple to contacts on the writing instrument,
the electronics to detect which electrical contacts are coupled to the contacts on the writing instrument, and provide a voltage to the identified contacts to charge a power supply in the writing instrument.

81. The apparatus of claim 80 in which the three electrical contacts comprise a first contact located in the center of the chamber and second contacts located at equal distances from the center towards first and second ends of the chamber.

82. The apparatus of claim 81 in which the second contacts are located at the first and second ends of the chamber.

83. An apparatus comprising:
an elongate pen body,
a first electrical contact on a surface of the pen body,
a light source disposed near an end of the pen body,
in which the light source comprises a light guide having an optically conductive portion and an optically reflective portion, the optically reflective portion also being electrically conductive and constituting a second electrical contact.

84. An apparatus comprising:
a housing containing electronics used in determining locations of a writing instrument based on wireless signals,
the housing defining a chamber in which the writing instrument may be held when not in use,
a clipboard sized to accommodate a sheet of paper,
the housing and the clipboard having mating features to removably couple the housing to the clipboard.

85. The apparatus of claim 84 in which the mating features comprise protrusions and holes on the clipboard and the housing.

86. The apparatus of claim 84 in which the mating features comprise springs and tabs extending from the housing and the clipboard.

87. An apparatus comprising:
a clipboard for use with a housing containing electronics used in determining locations of a writing instrument based on wireless signals, the clipboard including
coupling features for aligning the housing in a controlled position, and
alignment features for aligning paper in a known position relative to the controlled position of the housing.

88. An apparatus comprising:
a clipboard for use with a housing containing electronics used in determining locations of a writing instrument based on wireless signals,
the clipboard including coupling features for aligning the housing in a controlled position, and
the clipboard being shaped to accommodate paper with a long edge of the paper aligned to the housing.

89. An apparatus comprising:
a clipboard for use with a housing containing electronics used in determining locations of a writing instrument based on wireless signals, the clipboard including
coupling features for aligning the housing in a controlled position, and
paper retaining features to retain paper in a fixed location relative to the controlled position of the housing between times when the housing is removed and the housing is attached.

90. A light guide adapted for use in a writing instrument, the light guide comprising:
a tapered section defining an axis and having a first end of a first diameter and a second end of a second diameter,
the first end being adapted to receive light, and
the second end being adapted to reflect the light received at the first end from a path from the first end to the second end and generally parallel to the axis to a path exiting the light guide in a direction generally perpendicular to the axis.

91. The light guide of claim 90 in which a face of the second end defines a conical frustum coaxial with and recessed into the tapered section.

92. The light guide of claim 91 in which the conical frustum has an angle of around 45 degrees.

93. The light guide of claim 91 in which the light guide is to exit a body of the writing instrument at a position along its axis a distance of about 1 mm from the end of the frustum.

94. A light guide adapted for use in a writing instrument, the light guide comprising:
a first section having a first diameter and defining an axis,
a tapered section coaxial with the first section and having a first end of the first diameter coupled to the first section and a second end of a second diameter,
the first section being adapted to receive light and direct it to the tapered section, and
the second end of the tapered section being adapted to reflect light received from the first section from a path generally parallel to the axis to a path exiting the light guide in a direction generally perpendicular to the axis.

95. An apparatus comprising:
an elongate pen body,
a writing tip disposed at an end of the pen body,
a light source disposed near the writing tip,
a switch to detect when pressure is applied to the writing tip, and
a contact for receiving power to charge electronics within the apparatus.

96. The apparatus of claim 95 in which the switch is configured to be activated without allowing significant movement of the writing tip relative to the pen body.

97. The apparatus of claim 95 in which the switch is configured to be activated while allowing axial movement of the writing tip of only 0.2 mm relative to the pen body.

98. An apparatus comprising
a pen body,
a light guide partially disposed within the pen body, and outside diameter of the light guide being about equal to an inside diameter of the pen body,
a light source disposed within the pen body,
a fiber optic fiber configured to couple light from the light source to the light guide, and
a reflector disposed at an end of the light guide outside the pen body.

99. The apparatus of claim 98 in which the light guide defines a channel along an axis of the pen body sized to accommodate a pen cartridge.

100. The apparatus of claim 98 in which the reflector is configured to reflect light from a direction substantially parallel to an axis of the pen body to a direction substantially perpendicular to the axis of the pen body.

101. The apparatus of claim 98 in which the light guide has a cylindrical shape of about constant diameter along its length.
